(19) United States
(12) Patent Application Publication
(10) Pub. No.: US 2016/0294983 A1
(43) Pub. Date: Oct. 6, 2016

(54) MEMORY SHARING USING RDMA

(71) Applicant: MELLANOX TECHNOLOGIES LTD., Yokneam (IL)

(72) Inventors: Yevgeny Kliteynik, Karmiel (IL); Aviad Yehezkel, Yokneam Ilit (IL); Liran Liss, Atzmon (IL); Amir Vadai, Kibbutz Lehavot HaBashan (IL); Eli Cohen, Sde Yaakov (IL); Erez Shitrit, Hoshaaya (IL); Gabi Liron, Yokneam Ilit (IL)

(21) Appl. No.: 14/672,397

(22) Filed: Mar. 30, 2015

(51) Int. Cl. H04L 29/06; G06F 15/173; G06F 12/10

(52) U.S. Cl. CPC H04L 67/42; G06F 12/1009; G06F 15/17331; G06F 2212/69

(57) ABSTRACT

A method for data storage includes provisioning, in a cluster of computers, including at least first and second computers, which are connected to a packet data network, a range of RAM on the second computer for use by the first computer. Blocks of data are stored in the provisioned range for use by programs running on the first computer. Upon incurring a page fault on the first computer in response to a request for a page of virtual memory by a program running on the first computer, a block swap request is directed to the NIC of the first computer with respect to the requested page. In response to the block swap request, an RDMA read request is initiated by the NIC via the network to the NIC of the second computer, to retrieve the requested page from the provisioned range, so as to resolve the page fault.

### FIELD OF THE INVENTION

The present invention relates generally to computer systems, and particularly to sharing memory resources in clusters of computers.

### BACKGROUND

Memory sharing among computers in a cluster is becoming increasingly common, particularly in virtualized environments, such as data centers and cloud computing infrastructures. For example, U.S. Pat. No. 8,266,238 describes an apparatus including a physical memory configured to store data and a chipset configured to support a virtual machine monitor (VMM). The VMM is configured to map virtual memory addresses within a region of a virtual memory address space of a virtual machine to network addresses, to trap a memory read or write access made by a guest operating system, to determine that the memory read or write access occurs for a memory address that is greater than the range of physical memory addresses available on the physical memory of the apparatus, and to forward a data read or write request corresponding to the memory read or write access to a network device associated with the one of the plurality of network addresses corresponding to the one of the plurality of the virtual memory addresses.

Some memory sharing schemes take advantage of the remote direct memory access (RDMA) capabilities of network interface controllers (NICs) that connect the computers to the network. For example, Liang et al. describe the use of RDMA in this context in an article entitled, “Swapping to Remote Memory over InfiniBand: An Approach using a High Performance Network Block Device,” IEEE International Conference on Cluster Computing (CLUSTER 2005), IEEE Computer Society (2005). The authors describe a remote paging system for remote memory utilization in InfiniBand clusters, including implementation of a high-performance networking block device (HPBD) over InfiniBand fabric. The HPBD serves as a swap device of kernel Virtual Memory (VM) for efficient page transfer to/from remote memory servers. The authors claim that their HPBD performs quick-sort only 1.45 times slower than the local memory system, and up to 21 times faster than local disk, while its design is completely transparent to user applications.

Choi et al. describe a similar sort of approach in “A Remote Memory System for High Performance Data Processing,” International Journal of Future Computer and Communication 4:1 (February 2015), pages 50-54. The authors present the architecture, communication method and algorithm of an InfiniBand Block Device (IBD), which is implemented as a loadable kernel module for the Linux kernel. They state that their IBD can bring more performance gain for applications whose working sets are larger than the local memory on a node but smaller than idle memory available on the cluster.

### SUMMARY

Embodiments of the present invention that are described hereinbelow provide improved methods and apparatus for memory access in a cluster of computers.

There is therefore provided, in accordance with an embodiment of the invention, a method for data storage in a cluster of computers, including at least first and second computers, which have respective first and second random-access memories (RAM) and are connected to a packet data network by respective first and second network interface controllers (NICs). The method includes provisioning a range of the second RAM on the second computer for use by the first computer, and storing blocks of data in the range provisioned in the second RAM for use by programs running on the first computer. Upon incurring a page fault on the first computer in response to a request for a page of virtual memory by a program running on the first computer, a block swap request is directed to the first NIC with respect to the requested page. In response to the block swap request, the first NIC initiates a remote direct memory access (RDMA) read request via the network to the second NIC to retrieve the requested page from the range provisioned in the second RAM. Upon receiving in the first NIC an RDMA read response from the second NIC in reply to the RDMA read request, the first NIC writes the requested page to the first RAM so as to resolve the page fault.

Typically, the second NIC receives the RDMA read request and generates the RDMA read response without notification to a central processing unit (CPU) of the second computer of the RDMA read request or response.

In some embodiments, the method includes selecting, on the first computer, a page of memory to swap out of the first RAM, and initiating an RDMA write request by the first NIC via the network to the second NIC to write the selected page to the range provisioned in the second RAM. Typically, initiating the RDMA write request includes directing an instruction from a memory manager to a kernel-level block device driver on the first computer, which invokes the RDMA write request by the first NIC. Additionally or alternatively, provisioning the range of the second RAM includes receiving at the first computer a memory key allocated by the second computer to the second NIC with respect to the provisioned range, and initiating the RDMA write request includes submitting the memory key in the RDMA write request to the second NIC.

In a disclosed embodiment, directing the block swap request includes directing an instruction from a memory manager to a kernel-level block device driver on the first computer, which invokes the RDMA read request by the first NIC.

In some embodiments, provisioning the range of the second RAM includes receiving at the first computer an announcement transmitted over the network indicating that a portion of the second RAM is available for block storage, and sending, in response to the announcement, a memory allocation request from the first computer to the second computer to reserve the range. Typically, provisioning the range of the second RAM includes receiving at the first computer, in reply to the memory allocation request, a memory key allocated by the second computer to the second NIC with respect to the provisioned range, and initiating the RDMA read request includes submitting the memory key in the RDMA read request to the second NIC.

There is also provided, in accordance with an embodiment of the invention, a computing system, including at least first and second computers interconnected by a packet data network. The computer respectively include first and second central processing units (CPUs), first and second random-access memories (RAM), and first and second network interface controllers (NICs), which are connected to the packet data network. The second computer is configured to provision a range of the second RAM for use by the first computer and to receive from the first computer via the data network blocks of data for use by programs running on the first computer and to store the received blocks in the provisioned range. The first CPU is configured, upon incurring a page fault on the first computer in response to a request for a page of virtual memory by a program running on the first computer, to direct a block swap request to the first NIC with respect to the requested page. The block swap request causes the first NIC to initiate a remote direct memory access (RDMA) read request via the network to the second NIC to retrieve the requested page from the range provisioned in the second RAM, and upon receiving in the first NIC an RDMA read response from the second NIC in reply to the RDMA read request, to write the requested page to the first RAM so as to resolve the page fault.

There is additionally provided, in accordance with an embodiment of the invention, a computer software product, including a non-transitory computer-readable medium in which program instructions are stored, which instructions, when read by a first computer in a cluster of computers, including at least the first and a second computer, which have respective first and second random-access memories (RAM) and are connected to a packet data network by respective first and second network interface controllers (NICs), cause the first computer to store blocks of data in a range that provisioned in the second RAM for use by programs running on the first computer. The instructions cause the first computer, upon incurring a page fault in response to a request for a page of virtual memory by a program running on the first computer, to direct a block swap request to the first NIC with respect to the requested page, so as to cause the first NIC in response to the block swap request, to initiate a remote direct memory access (RDMA) read request via the network to the second NIC to retrieve the requested page from the range provisioned in the second RAM, such that upon receiving in the first NIC an RDMA read response from the second NIC in reply to the RDMA read request, the first NIC writes the requested page to the first RAM so as to resolve the page fault.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system, in accordance with an embodiment of the invention;

FIG. 2 is a block diagram that schematically illustrates functional elements of a computer system, in accordance with an embodiment of the invention; and

FIGS. 3 and 4 are flow charts that schematically illustrate methods for block storage using RDMA, in accordance with an embodiment of the invention.

### DETAILED DESCRIPTION OF EMBODIMENTS

Computer operating systems use virtual memory techniques to permit application programs to address a contiguous working memory space, even when the corresponding physical (machine) memory space is fragmented and may overflow to a block storage device, such as a disk. The virtual memory address space is typically divided into pages, and the computer memory management unit (MMU) uses page tables to translate the virtual addresses of the application program into physical addresses. The virtual address range may exceed the amount of actual physical random access memory (RAM), in which case block storage space is used to save (“swap out”) virtual memory pages that are not currently active. When an application attempts to access a virtual address that is absent from the physical memory, the MMU raises a page fault exception (commonly referred to simply as a “page fault”), which causes the operating system to swap the required page back from the block storage device into the memory.

When a page fault occurs in a software process running on a host central processing unit (CPU), the process typically stops at the instruction that caused the page fault (after completing all prior instructions). The process is suspended until the appropriate page of virtual memory has been swapped into RAM from the disk, and then resumes its operation. The high latency of disk access, however, can seriously degrade program performance.

Embodiments of the present invention that are described hereinbelow address this problem by enabling computers in a cluster to take advantage of a part of the RAM available on another computer or computers as a swap device, as though it were a local block storage device. The computer that allocates a part of its RAM for this purpose is referred to herein as a remote RAM server, while computers using the RAM as a remote swap device are referred to as remote RAM clients. The clients initiate RDMA write and read operations over a high-speed network linking the computers in the cluster in order swap data from their local RAM into and out of the server RAM. At the server side, the RDMA operations are handled by the NIC without notification to the server CPU of the incoming RDMA request or any need for involvement by the server CPU in generating a response. The server CPU is generally involved only in the preliminary stage of provisioning a range of its RAM for use by the clients, for example by announcing over the network that it has memory available for use as block storage and accepting memory allocation requests from the clients.

Embodiments of the present invention thus take advantage of the high speed of network interaction in the cluster, and specifically the speed with which modern NICs are able to carry out data exchange by RDMA. Although this sort of remote memory access is much slower than access to the local RAM of the computer, RDMA over a high-speed network with suitable NICs, such as in an InfiniBand (IB) or Data Center Ethernet (DCE) infrastructure, can still be far faster than access to a disk or other storage memory. The use of the memory of the RAM server for block storage is further simplified and accelerated by the fact that once provisioning has been completed, memory swap operations can be handled without any involvement of the server CPU.

Thus, some embodiments of the present invention provide a method for data storage in a cluster of computers, which includes at least first and second computers, such as a client computer and a RAM server, which have respective local RAM and are connected to a packet data network by respective client and server NICs. A range of the RAM on the server is provisioned for use by the client computer, which then stores blocks of data in this range for use by programs running on the client computer. When the client computer incurs a page fault in response to a request for a page of virtual memory by a program running on the client computer, the client computer directs a block swap request to the client NIC with respect to the requested page. To carry out this request, a driver program on the client computer initiates an RDMA read request by the client NIC via the network to the server NIC, asking to retrieve the requested page from the range provisioned in the server RAM. In reply to this request, the server NIC sends an RDMA read response to the client NIC, which then receives the response and writes the requested page to the local RAM of the client computer so as to resolve the page fault.

The block swap request on the client computer typically takes the form of an instruction from the memory manager to a kernel-level block device driver on the client computer, which invokes the RDMA read request by the client NIC. As noted above, the server NIC typically receives the RDMA read request and generates the RDMA read response without notification to the CPU of the server of the RDMA read request or response.

Typically, the client computer also selects pages of memory to swap out of the RAM, and initiates RDMA write requests by the client NIC via the network to the server NIC to write the selected pages to the range provisioned in the RAM of the server, thus freeing space in the local RAM of the client computer.

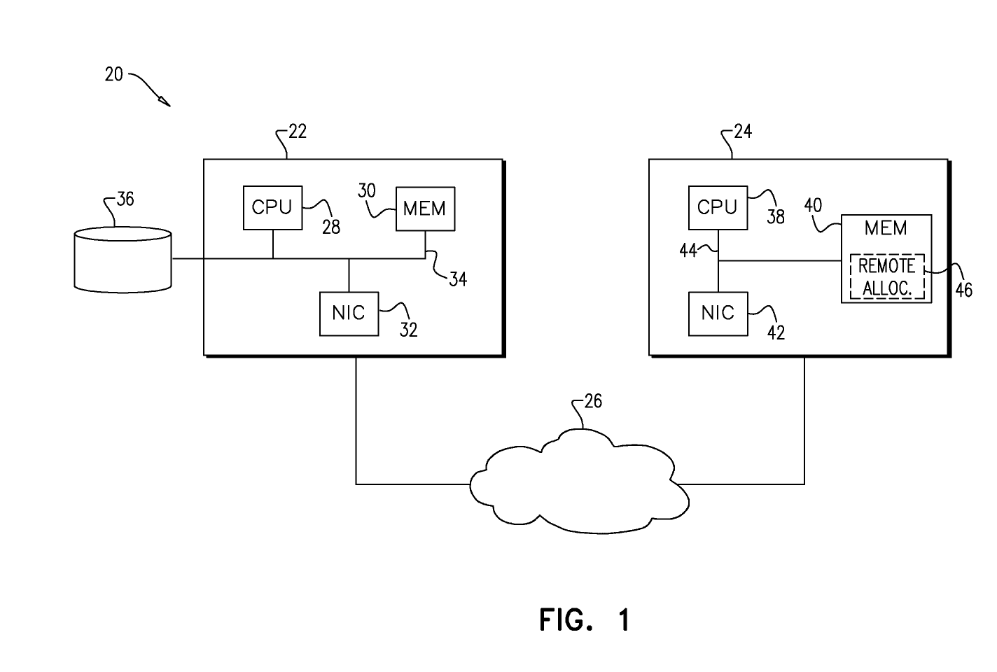

FIG. 1 is a block diagram that schematically illustrates a computer system 20, in accordance with an embodiment of the invention. System 20 comprises computers 22 and 24, which are interconnected by a network 26, such as an InfiniBand or Ethernet switch fabric. Computers 22 and 24 also referred to, in the context of the present embodiment, as the remote RAM (RRAM) client and server, respectively. Although for the sake of simplicity, only a single client and a single server are shown in FIG. 1, practical systems will typically comprise many computers, including multiple RRAM clients and possibly multiple RRAM servers, as well.

Computers 22 and 24 comprise respective CPUs 28, 38, which typically comprise general-purpose computer processors, with respective local RAM 30, 40 and NICs 32, 42 connecting the computers to network 26. NICs 32 and 42 are typically connected to the other components of computers 22 and 24 by respective buses 34, 44, such as PCI Express buses. In this example, computer 22 also comprises a local block storage device 36, such as a solid-state drive or magnetic disk. For block storage that is sensitive to latency, however, computer 22 makes use of a remote RAM allocation 46 in memory 40 of computer 24, which it accesses by means of RDMA requests and responses that are exchanged over network 26 between NICs 32 and 42. Computer 24 may serve multiple remote RAM clients in this manner.

Some of the operations of computers 22 and 24 in the context of the present embodiments, such as provisioning of remote RAM allocation 46 on computer 24 and translation of memory swap operations on computer 22 into RDMA work items for execution by NIC 32, are typically carried out by software program instructions running on CPU 28 or 38. The software may be downloaded to computers 22 and 24 in electronic form, over network 26, for example. Additionally or alternatively, the software may be provided and/or stored on tangible, non-transitory computer-readable media, such as optical, magnetic, or electronic memory media.

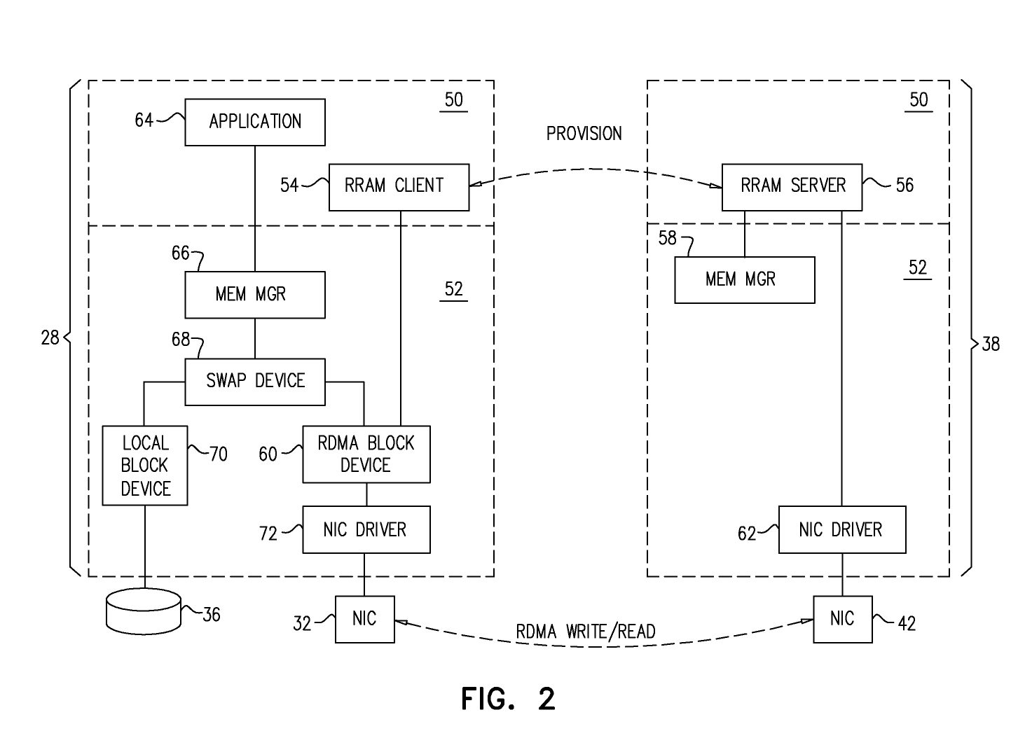

FIG. 2 is a block diagram that schematically illustrates functional elements of system 20, in accordance with an embodiment of the invention. These functional components are typically implemented in software running on CPUs 28 and 38 (of computers 22 and 24, respectively), and include both user-space programs, which run in a user space 50 of the computers, and kernel-space programs, which run in a trusted kernel space 52. Alternatively, some of the functions shown in FIG. 2 may be implemented in dedicated or programmable hardware logic.

Provisioning of remote RAM allocation 46 is carried out by communication between an RRAM client program 54 running on CPU 28 and an RRAM server program 56 running on CPU 38. Programs 54 and 56 may conveniently run in user space 50 and communicate over network 26 (via NICs 32 and 42) using an out-of band protocol, which is separate and distinct from the RDMA operations used for block data transfer. Alternatively, programs 54 and 56 may exchange provisioning information using any suitable protocol that is known in the art and may run in kernel space 52.

As a part of the provisioning process, server program 56 issues an announcement over network 26 indicating that a portion of RAM 46 is available for block storage. The announcement may comprise, for example, either a multicast message to potential clients in system 20 or a unicast message directed to client program 54 on computer 22. Client program 54 responds to the announcement by sending a memory allocation request to server program 56 to reserve a certain range in memory 40. The size of the range may be determined by negotiation between client program 54 and server program 56.

Once the negotiation (if any) is done, server program 56 responds to the memory allocation request by sending addressing parameters of remote allocation 46 to client program 54. The addressing parameters typically comprise a starting address and length of allocation 46, expressed in terms of either physical addresses or virtual addresses in memory 40. The addressing parameters also include a memory key allocated by computer 24 to NIC 42 with respect to range 46 that has been provisioned for use by computer 22. The key is allocated by a memory management program 58 running on CPU 38 and is supplied to a NIC driver program 62, which typically stores the key in a memory translation table used by NIC 42 in processing RDMA requests. Client program 54 on computer 22 receives and passes this key to an RDMA block device driver program 60 running on CPU 28 for use in generating RDMA read and write requests sent by NIC 32 to NIC 42.

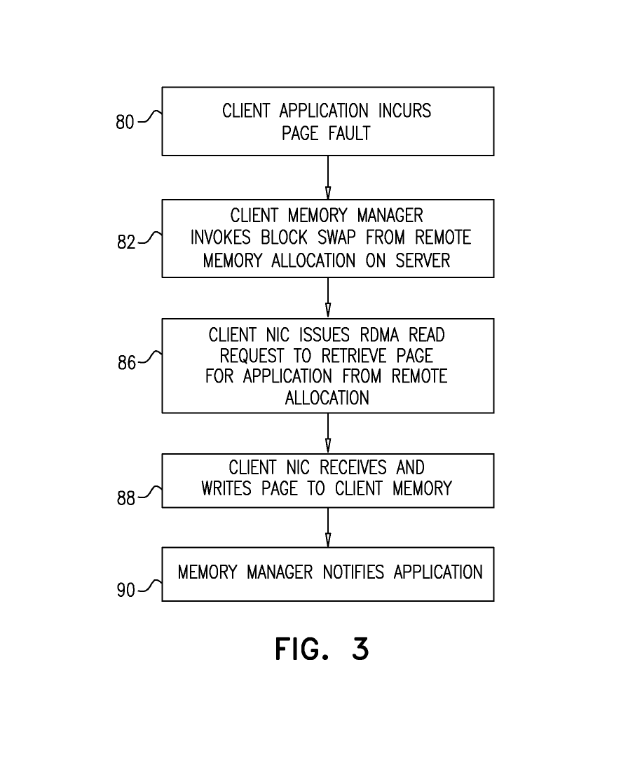

FIG. 3 is a flow chart that schematically illustrates a method for block storage using RDMA, in which a page is swapped into memory 30 from remote allocation 46, in accordance with an embodiment of the invention. This method is described, for the sake of convenience and clarity, with reference to the elements of system 20 and the functional components that are shown in FIG. 2. The description assumes, as its point of departure, that remote allocation 46 has already been provisioned in memory 40. This provisioning may be carried out in the manner described above, by communication between RRAM client and server programs 54 and 56. Alternatively, remote allocation 46 may be provisioned using any suitable technique that is known in the art, such as static provisioning by a system operator.

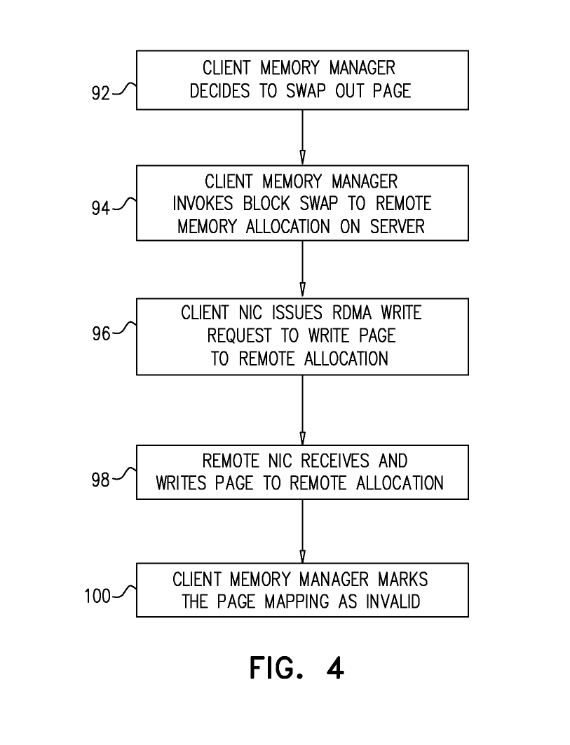

The method of FIG. 3 is initiated when a client application 64, such as a user program running on CPU 28, incurs a page fault with respect to a request for a certain page in memory 30, at a page fault step 80. In response to the page fault, a memory management program 66 running on CPU 28 invokes a block swap operation to swap in the requested page from block storage, at a swap request step 82. The swap request is handled by a swap device driver (FIG. 2) running on CPU 28, which operates in a manner that is substantially similar to drivers of this sort that are known in the art for swapping block data to and from storage media, such as local block storage device 36. Driver 68 is capable of interacting both with a local block device driver program 70, which connects to device 36, and with RDMA block device driver program 60 in substantially the same manner, as though both device 36 and remote allocation 46 were local block storage devices. (Local block storage device 36 is optional, however, and may be eliminated, along with program 70, if sufficient storage space is available in remote allocation 46.) Assuming that the desired page is located in remote allocation 46, swap device driver 68 will invoke retrieval of the block containing the page by NIC 32 via RDMA block device driver program 60. Assuming there is sufficient free space in memory 30 to receive the page that is to be swapped in from remote allocation 46, swap device driver 68 instructs program 60 to swap the desired page in to the appropriate physical address in memory 30, at a swapping in step 86. (Memory management program 66 frees space in memory 30 by swapping pages out to remote allocation 46, as described hereinbelow with reference to FIG. 4.) Program 60 submits an RDMA read request to NIC driver 72 to retrieve the block containing the desired page and to write it to the appropriate address in memory 30. As a result, driver 72 queues an RDMA read work item for execution by NIC 32. To execute the work item, NIC 32 transmits an RDMA read request packet to NIC 42, specifying the address parameters in remote allocation 46 for retrieval of the desired memory block. NIC 42 responds by reading the specified data from memory 40 (again, without notification to or involvement by CPU 38) and returning the data to NIC 32 in one or more RDMA read response packets.

NIC 32 receives the read response packets from NIC 44, and writes the data to the address in memory that was indicated by the original RDMA read request, at a page writing step 88. NIC 32 then notifies memory management program 66 that the desired page of data has been swapped in at the specified address in memory 30. For example, NIC 32 may write a completion report to a completion queue in memory 30, which is read by driver program 60, which then passes the notification up the chain to memory management program 66. The memory management program notifies application 64 that the faulted page is now valid, at a notification step 90, and execution of the application continues.

FIG. 4 is a flow chart that schematically illustrates a method for block storage using RDMA, in which a page is swapped out of memory 30 to remote allocation 46, in accordance with an embodiment of the invention. Memory management program 66 decides to swap out a page that is not currently needed from memory 30 to remote allocation 46, at a swapping decision step 92. Any suitable criterion can be used to choose the page that will be swapped out, such as choosing the page that has been least recently used (LRU).

Memory management program 66 invokes a block swap operation to swap out the chosen page to block storage, at a swap request step 94. The swap request is handled by swap device driver 68, which invokes transmission of the block containing the page by NIC 32 via RDMA block device driver program 60. Program 60 submits an RDMA write request to a NIC driver 72 running on CPU 28, which accordingly queues an RDMA write work item for execution by NIC 32, at a write request step 96. When the work item reaches the head of the queue, NIC 32 transmits one or more RDMA write request packets over network 26, containing the data in the page that is to be swapped out to NIC 42. The packets specify the address in remote allocation 46 to which the data are to be written, together with the appropriate memory key for the address.

Upon receiving the packets, NIC 42 writes the data to the specified address in memory 40 and returns an acknowledgment to NIC 32, at a page writing step 98. In general, NIC 42 writes the data to memory 40 by direct memory access (DMA), without notification to or software involvement by CPU 38. Memory management program 66 marks the mapping of the page that has been swapped out of memory 30 as invalid, at an invalidation step 100. The physical page in question thus becomes available for swapping in of a new page of data from remote allocation 46.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for data storage, comprising:
in a cluster of computers, including at least first and second computers, which have respective first and second random-access memories (RAM) and are connected to a packet data network by respective first and second network interface controllers (NICs), provisioning a range of the second RAM on the second computer for use by the first computer;
storing blocks of data in the range provisioned in the second RAM for use by programs running on the first computer;
upon incurring a page fault on the first computer in response to a request for a page of virtual memory by a program running on the first computer, directing a block swap request to the first NIC with respect to the requested page;
in response to the block swap request, initiating a remote direct memory access (RDMA) read request by the first NIC via the network to the second NIC to retrieve the requested page from the range provisioned in the second RAM; and
upon receiving in the first NIC an RDMA read response from the second NIC in reply to the RDMA read request, writing the requested page from the first NIC to the first RAM so as to resolve the page fault.

2. The method according to claim 1, wherein the second NIC receives the RDMA read request and generates the RDMA read response without notification to a central processing unit (CPU) of the second computer of the RDMA read request or response.

3. The method according to claim 1, and comprising selecting, on the first computer, a page of memory to swap out of the first RAM, and initiating an RDMA write request by the first NIC via the network to the second NIC to write the selected page to the range provisioned in the second RAM.

4. The method according to claim 3, wherein initiating the RDMA write request comprises directing an instruction from a memory manager to a kernel-level block device driver on the first computer, which invokes the RDMA write request by the first NIC.

5. The method according to claim 3, wherein provisioning the range of the second RAM comprises receiving at the first computer a memory key allocated by the second computer to the second NIC with respect to the provisioned range, and wherein initiating the RDMA write request comprises submitting the memory key in the RDMA write request to the second NIC.

6. The method according to claim 1, wherein directing the block swap request comprises directing an instruction from a memory manager to a kernel-level block device driver on the first computer, which invokes the RDMA read request by the first NIC.

7. The method according to claim 1, wherein provisioning the range of the second RAM comprises receiving at the first computer an announcement transmitted over the network indicating that a portion of the second RAM is available for block storage, and sending, in response to the announcement, a memory allocation request from the first computer to the second computer to reserve the range.

8. The method according to claim 7, wherein provisioning the range of the second RAM comprises receiving at the first computer, in reply to the memory allocation request, a memory key allocated by the second computer to the second NIC with respect to the provisioned range, and wherein initiating the RDMA read request comprises submitting the memory key in the RDMA read request to the second NIC.

9. A computing system, comprising at least first and second computers interconnected by a packet data network, and which respectively comprise:
first and second central processing units (CPUs);
first and second random-access memories (RAM); and
first and second network interface controllers (NICs), which are connected to the packet data network,
wherein the second computer is configured to provision a range of the second RAM for use by the first computer and to receive from the first computer via the data network blocks of data for use by programs running on the first computer and to store the received blocks in the provisioned range, and
wherein the first CPU is configured, upon incurring a page fault on the first computer in response to a request for a page of virtual memory by a program running on the first computer, to direct a block swap request to the first NIC with respect to the requested page,
wherein the block swap request causes the first NIC to initiate a remote direct memory access (RDMA) read request via the network to the second NIC to retrieve the requested page from the range provisioned in the second RAM, and upon receiving in the first NIC an RDMA read response from the second NIC in reply to the RDMA read request, to write the requested page to the first RAM so as to resolve the page fault.

10. The system according to claim 9, wherein the second NIC receives the RDMA read request and generates the RDMA read response without notification to the second CPU of the RDMA read request or response.

11. The system according to claim 9, wherein the first CPU is configured to select, on the first computer, a page of memory to swap out of the first RAM, and to initiate an RDMA write request by the first NIC via the network to the second NIC to write the selected page to the range provisioned in the second RAM.

12. The system according to claim 9, wherein the block swap request is carried out by directing an instruction from a memory manager to a kernel-level block device driver on the first computer, which invokes the RDMA read request by the first NIC.

13. The system according to claim 9, wherein the second CPU is configured to transmit an announcement over the network indicating that a portion of the second RAM is available for block storage, and the first CPU is configured to send, in response to the announcement, a memory allocation request to the second computer to reserve the range.

14. The system according to claim 13, wherein the second CPU is configured to send to the first computer, in reply to the memory allocation request, a memory key allocated by the second computer to the second NIC with respect to the provisioned range, and wherein the first NIC is configured to submit the memory key in the RDMA read request to the second NIC.

15. A computer software product, comprising a non-transitory computer-readable medium in which program instructions are stored, which instructions, when read by a first computer in a cluster of computers, including at least the first and a second computer, which have respective first and second random-access memories (RAM) and are connected to a packet data network by respective first and second network interface controllers (NICs), cause the first computer to store blocks of data in a range that provisioned in the second RAM for use by programs running on the first computer,
wherein the instructions cause the first computer, upon incurring a page fault in response to a request for a page of virtual memory by a program running on the first computer, to direct a block swap request to the first NIC with respect to the requested page, so as to cause the first NIC in response to the block swap request, to initiate a remote direct memory access (RDMA) read request via the network to the second NIC to retrieve the requested page from the range provisioned in the second RAM, such that upon receiving in the first NIC an RDMA read response from the second NIC in reply to the RDMA read request, the first NIC writes the requested page to the first RAM so as to resolve the page fault.

16. The product according to claim 15, wherein the second NIC receives the RDMA read request and generates the RDMA read response without notification to a central processing unit (CPU) of the second computer of the RDMA read request or response.

17. The product according to claim 15, wherein the instructions cause the first computer to select a page of memory to swap out of the first RAM, and to initiate an RDMA write request by the first NIC via the network to the second NIC to write the selected page to the range provisioned in the second RAM.

18. The product according to claim 15, wherein the instructions cause the first computer to direct an instruction from a memory manager to a kernel-level block device driver on the first computer, which invokes the RDMA read request by the first NIC.

19. The product according to claim 15, wherein the instructions cause the first computer to receive an announcement transmitted over the network indicating that a portion of the second RAM is available for block storage, and to send, in response to the announcement, a memory allocation request from the first computer to the second computer to reserve the range.

20. The product according to claim 17, wherein the instructions cause the first computer to receive, in reply to the memory allocation request, a memory key allocated by the second computer to the second NIC with respect to the provisioned range, and to cause the first NIC to submit the memory key in the RDMA read request to the second NIC.
